(19) United States
(12) Patent Application Publication
(10) Pub. No.: US 2016/0307713 A1
(43) Pub. Date: Oct. 20, 2016

(54) KEYBOARD DEVICE

(71) Applicant: Changshu Sunrex Technology Co., Ltd., Changshu (CN)

(72) Inventor: Qing ZHANG, Changshu (CN)

(21) Appl. No.: 14/691,035

(22) Filed: Apr. 20, 2015

(51) Int. Cl. H01H 13/70

(52) U.S. Cl. CPC H01H 13/7013

(57) ABSTRACT

A keyboard device includes: a keyboard base; a circuit board disposed on the keyboard base and including a plurality of triggers; a keycap unit disposed on the circuit board and including a plurality of keycaps; and an elastic unit including a plurality of elastic members each being disposed between one of the keycaps and one of the triggers. The number of the keycaps is less than that of the triggers. Each of the keycaps covers at least one trigger. Each of at least two of the keycaps covers a plurality of the triggers. When one of the elastic members is pressed by a corresponding one of the keycaps, it activates a corresponding one of the triggers.

### FIELD

The disclosure relates to a keyboard device, and more particularly to a keyboard device including elements that are mutually compatible for multiple types of keyboards.

### BACKGROUND

In general, conventional keyboard devices are divided into several types, such as an American keyboard, a British keyboard and a Portuguese Brazil keyboard. Each conventional keyboard device includes a keyboard base, a circuit board, a plurality of keycaps, an elastic unit, a frame structure, etc. However, since the layouts of the keycaps in each type of the keyboards are different from one another, the aforesaid elements in each type of the keyboards cannot be used for another type of the keyboards. For example, the frame structure of an American keyboard is different from that of a British keyboard. Therefore, the frame structure of the American keyboard is not compatible for other types of the keyboards. Since the aforesaid elements of the conventional keyboard devices are not compatible, the manufacturing cost and the storage cost of the conventional keyboard devices are increased.

### SUMMARY

Therefore, an object of the disclosure is to provide a keyboard device that can alleviate at least one of the drawbacks of the prior arts.

According to the disclosure, the keyboard device includes a keyboard base, a circuit board, a keycap unit and an elastic unit. The circuit board is disposed on the keyboard base and includes a plurality of triggers that are spaced apart from one another. The keycap unit is disposed on a side surface of the circuit board opposite to the keyboard base and includes a plurality of keycaps that are spaced apart from one another. The number of the keycaps is less than that of the triggers. Each of the keycaps covers at least one of the triggers. Each of at least two of the keycaps covers a plurality of the triggers. The elastic unit includes a plurality of elastic members each being disposed between a corresponding one of the keycaps and a corresponding one of the triggers. The number of the elastic members is less than that of the triggers. When one of the elastic members is pressed by a corresponding one of the keycaps, it activates the corresponding one of the triggers.

### BRIEF DESCRIPTION OF THE DRAWINGS

Other features and advantages of the disclosure will become apparent in the following detailed description of the embodiments with reference to the accompanying drawings, of which:

FIG. 1 is an exploded perspective view illustrating an American keyboard of a first embodiment of a keyboard device according to the disclosure;

FIG. 2 is a fragmentary schematic side view illustrating the American keyboard of the first embodiment;

FIG. 3 is an exploded perspective view illustrating a British keyboard of the first embodiment of a keyboard device according to the disclosure;

FIG. 4 is a fragmentary schematic side view illustrating the British keyboard of the first embodiment;

FIG. 5 is an exploded perspective view illustrating a Portuguese Brazil keyboard of the first embodiment of a keyboard device according to the disclosure;

FIG. 6 is another fragmentary schematic side view illustrating the British keyboard of the first embodiment;

FIG. 7 is a fragmentary schematic side view illustrating the Portuguese Brazil keyboard of the first embodiment;

FIG. 8 is an exploded perspective view illustrating an American keyboard of a second embodiment of a keyboard device according to the disclosure;

FIG. 9 is a fragmentary schematic side view illustrating the American keyboard of the second embodiment;

FIG. 10 is an exploded perspective view illustrating a British keyboard of the second embodiment of a keyboard device according to the disclosure;

FIG. 11 is a fragmentary schematic side view illustrating the British keyboard of the second embodiment;

FIG. 12 is an exploded perspective view illustrating a Portuguese Brazil keyboard of the second embodiment of a keyboard device according to the disclosure;

FIG. 13 is another fragmentary schematic side view illustrating the British keyboard of the second embodiment; and

FIG. 14 is a fragmentary schematic side view illustrating the Portuguese Brazil keyboard of the second embodiment.

### DETAILED DESCRIPTION

It should be noted that, the terms “above” and “under” in the description only represents a relative position. In this disclosure, the term “above” or the like represents a side that is closer to the user in space, while the term “under” or the like represents a side that is more distant from the user in space. However, the relative position is just an example for illustration and should not be taken as a limitation of this disclosure.

Before the disclosure is described in greater detail, it should be noted that like elements are denoted by the same reference numerals throughout the disclosure.

### The First Embodiment

The first embodiment of a keyboard device 100 according to this disclosure includes a keyboard base 1, a circuit board 2, a keycap unit 3, an elastic unit 4, a frame structure 5 and a plurality of guiding structures 6.

The first embodiment includes three examples respectively illustrating an American keyboard, a British keyboard, and a Portuguese Brazil keyboard.

In the three examples, the components of the keyboard device 100 are divided into two types: a mutually compatible element that is suitable for all the types of the keyboards and a mutually incompatible element that is only suitable for one of the types of the keyboards. The detailed description is as followed.

### (1) Example 1

### American Keyboard

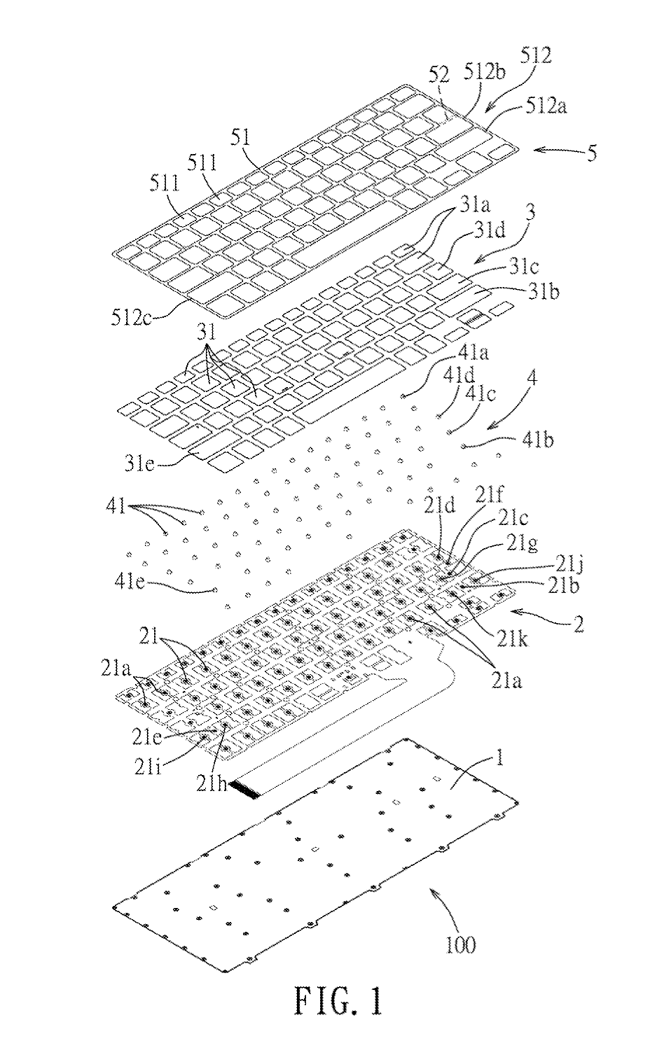

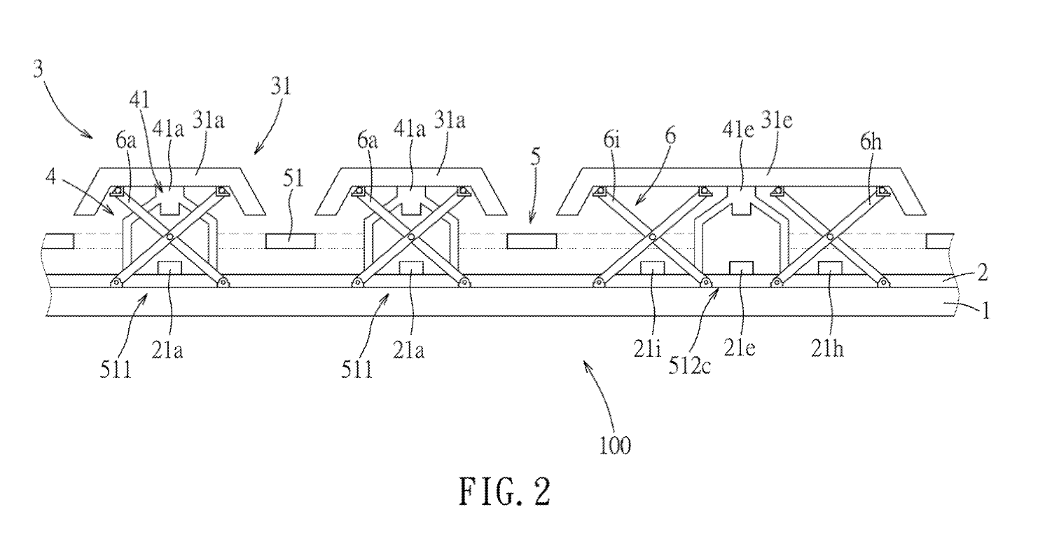

FIGS. 1 and 2 show an American keyboard of the first embodiment according to this disclosure.

The keyboard base 1 is a compatible element and can be made of a metallic material or a plastic material, and is configured as a bottommost layer of the keyboard device 100 (i.e., the circuit board 2, the keycap unit 3, the elastic unit 4, the frame structure 5 and the guiding structures 6 are all disposed above the keyboard base 1).

The circuit board 2 is a compatible element and is disposed on the keyboard base 1, and includes a plurality of triggers 21 that are spaced apart from one another. When one of the triggers 21 is pressed by the elastic unit 4, the circuit board 2 generates a signal corresponding to the keyboard function. In order to distinguish the triggers 21 from each other, the triggers 21 are divided into 21a˜21k. In all types of the keyboards, the trigger 21a conducts the same electrical function. Only some of the triggers 21b˜21k conduct electrical functions. For example, for the American keyboard, only 21b, 21c, 21d and 21e are used for generating electrical signals. The triggers 21f˜21k are not used in this example, but can be used in other types of the keyboards (see Example 2 and Example 3 in the following).

The keycap unit 3 is disposed on a side surface of the circuit board 2 opposite to the keyboard base 1, and includes a plurality of keycaps 31 that are spaced apart from one another. In order to distinguish the keycaps 31 from each other, the keycaps 31 are divided into the 31a˜31e. The keycaps 31a are compatible elements. The keycaps 31b˜31e are incompatible elements. For the conventional keyboard, the number of the keycaps is the same as that of the triggers. However, in this embodiment, the number of the keycaps 31 is less than that of the triggers 21, each of the keycaps 31 covers at least one of the triggers 21, and each of at least two of the keycaps 31 covers a plurality of the triggers 21. For example, each of the keycaps 31a covers only a corresponding one of the triggers 21a. The keycap 31b covers a plurality of triggers 21b, 21j, 21k. The keycap 31c covers a plurality of triggers 21c, 21g. The keycap 31d covers only one trigger 21d. The keycap 31e covers a plurality of triggers 21e, 21h, 21i. However, it should be noted that, no matter how many triggers 21 are covered by each of the keycaps 31, when one of the keycaps 31 is pressed by the user, only one corresponding trigger 21 will be activated. For example, when one of the keycaps 31a is pressed, only the corresponding one trigger 21a is activated. When the keycap 31b is pressed, the triggers 21b is activated while the triggers 21j, 21k are not. When the keycap 31c is pressed, the trigger 21c is activated while the trigger 21g is not. When the keycap 31d is pressed, the trigger 21d is activated. When the keycap 31e is pressed, the trigger 21e is activated while the triggers 21h, 21i are not. Although the triggers 21f˜21k are not used in the American keyboard, they can be used for other types of the keyboards (see Example 2 and Example 3).

The elastic unit 4 includes a plurality of elastic members 41 each being disposed between a corresponding one of the keycaps 31 and a corresponding one of the triggers 21. The elastic unit 4 can be made of, for example but not limited to, rubber, silica gel, or a metallic material. The number of the elastic members 41 is the same as that of the keycaps 31. In other words, the number of the elastic members 41 is less than that of the triggers 21. To be specific, each of the elastic members 41 is corresponding in position to a respective one of the keycaps 31. When one of the keycaps 31 is pressed, the corresponding one of the elastic members 41 is pressed thereby deforming so as to activate the corresponding one of the triggers 21. In order to distinguish the elastic members 41 from each other, the elastic members 41 are divided into the elastic members 41a˜41e. When one of the elastic members 41 is pressed by a corresponding one of the keycaps 31, the one of the elastic members 41 activates the corresponding one of the triggers 21. In the configuration of the American keyboard, the elastic member 41a, the keycap 31a, and the trigger 21a are aligned along a vertical direction. Similarly, the elastic member 41b, the keycap 31b, and the trigger 21b are aligned with one another. The elastic member 41c, the keycap 31c, and the trigger 21c are aligned with one another. The elastic member 41d, the keycap 31d, and the trigger 21d are aligned with one another. The elastic member 41e, the keycap 31e, and the trigger 21e are aligned with one another. In this embodiment, the elastic members 41 are adhered to the circuit board 2.

The frame structure 5 can be made of a plastic material or a metallic material, and includes a main frame unit 51 and at least one partition strip 52. The main frame unit 51 is disposed on a side surface of the circuit board 2 opposite to the keyboard base 1 and includes a plurality of first frames 511 and at least two second frames 512. Each of the first frames 511 defines a hole for receiving a corresponding one of the keycaps 31a therein. Each of the second frames 512 defines a hole that is greater than that of each of the first frames 511. At least one of the holes of the second frames 512 receives a plurality of corresponding ones of the keycaps 31b˜31e therein. At least one partition strip 52 is mounted on one of the second frames 512 and is disposed between two of the keycaps 31 received in the one of the second frames 512 so as to partition the keycaps 31 received in the one of the second frames 512. In order to distinguish the second frames 512 from each other, the second frames 512 are divided into the second frames 512a˜512c. To be more specific, the second frame 512a receives the keycap 31b therein. The second frame 512b receives the keycaps 31c, 31d therein. The partition strip 52 is mounted on the second frame 512b and is disposed between the keycaps 31c, 31d so as to partition the keycaps 31c, 31d (see FIG. 1). The second frame 512c receives the keycap 31e therein.

The guiding structures 6 are compatible elements and are illustrated by scissor-switch mechanisms in this disclosure. However, the configuration of the guiding structures 6 is not limited thereto. The guiding structures 6 are not shown in FIG. 1 for the sake of simplicity. Each of the guiding structures 6 interconnects a corresponding one of the keycaps 31 and the keyboard base 1 to guide the corresponding one of the keycaps 31 to move upwardly and downwardly. Each of the keycaps 31 is connected to at least one of the guiding structures 6. The number of the guiding structures 6 is less than that of the triggers 21. In order to distinguish the guiding structures 6 from each other, the guiding structures 6 are divided into the guiding structures 6a, 6h, 6i, 6j, 6k. Referring to FIG. 2, in this example, each of the keycaps 31a is connected to a respective one of the guiding structures 6a, and the keycap 31e is connected to both the guiding structures 6i, 6h.

### (2) Example 2

### British Keyboard

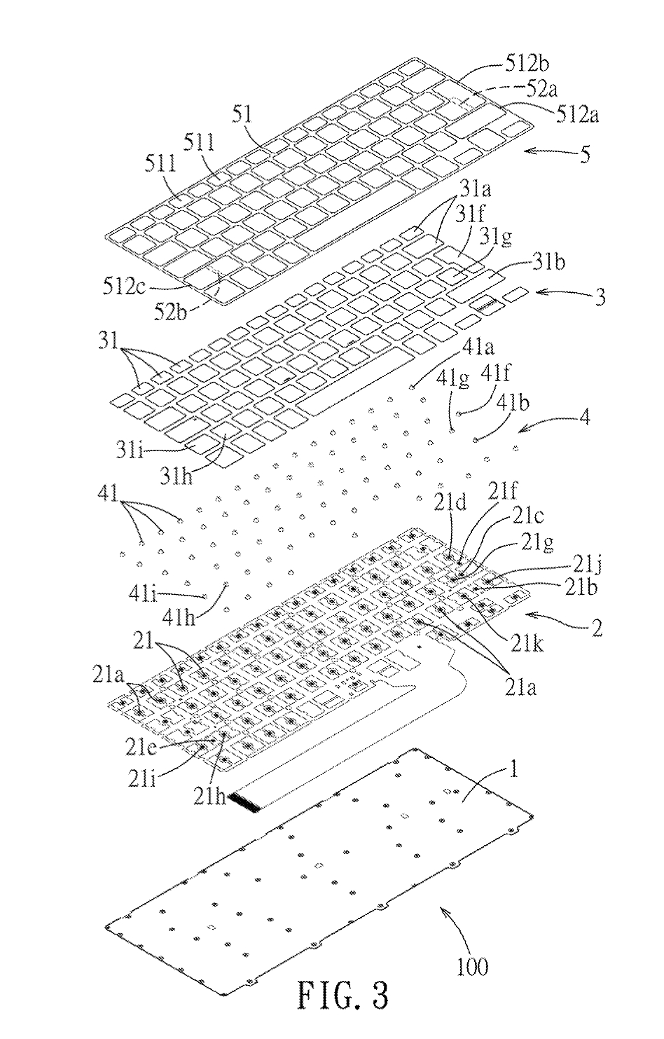

FIGS. 3, 4 and 6 show a British keyboard of the first embodiment according to this disclosure.

The British keyboard (Example 2) has a structure similar to that of the American keyboard (Example 1) except for the keycap unit 3, the elastic members 41 and the partition strip 52.

The keycaps 31a, 31b are similar to that of Example 1. The keycaps 31c, 31d of Example 1 are replaced by the keycaps 31f, 31g. The keycap 31e of Example 1 is replaced by the keycaps 31h, 31i (comparing FIGS. 1 and 3).

The elastic members 41a, 41b are similar to that of Example 1. The elastic members 41f, 41g, 41h, 41i replace the elastic members 41c, 41d, 41e of Example 1 and are respectively disposed under the keycaps 31f, 31g, 31h, 31i to bias the elastic members 41 to their original position.

In this example, the frame structure 5 includes two partition strips 52a, 52b. The partition strip 52a is mounted on the second frame 512b and is disposed between the keycaps 31f, 31g received in the second frame 512b so as to partition the keycaps 31f, 31g. Similarly, the partition strip 52b is mounted on the second frame 512c and is disposed between the keycaps 31h, 31i received in the second frame 512c so as to partition the keycaps 31h, 31i.

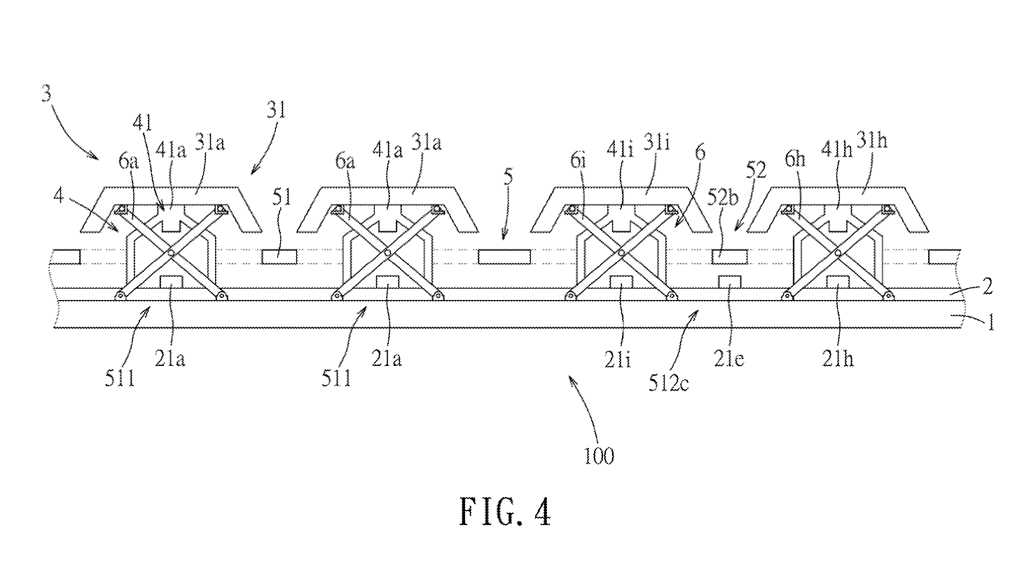

Comparing FIGS. 2 and 4, as shown in FIG. 2, for the American keyboard, the keycap 31e covers the triggers 21e, 21h, 21i. However, as shown in FIG. 4, for the British keyboard, the keycaps 31h, 311 replace the keycap 31e in the American keyboard and respectively cover the triggers 21h, 21i. That is to say, the keycap 31h is only connected to the elastic member 41h and only covers the trigger 21h. The keycap 31i is only connected to the elastic member 41i and only covers the trigger 21i. When the keycaps 31h, 31i are pressed, the elastic members 41h, 41i are pressed to deform so as to activate the triggers 21h, 21i which are not used in the American keyboard (Example 1).

To sum up, though the layout of the keycaps 31 are different in different types of the keyboards, due to the configuration of the keyboard base 1, the circuit board 2, the main frame unit 51 and the guiding structure 6, the aforesaid elements are compatible elements that are suitable for both the American keyboard and the British keyboard, thereby increasing the compatibility of the elements. The configuration of the keycaps 31, the elastic members 41 and the partition strip(s) 52 can be adjusted to meet actual requirements depending on the type of the keyboard.

### (3) Example 3

### Portuguese Brazil Keyboard

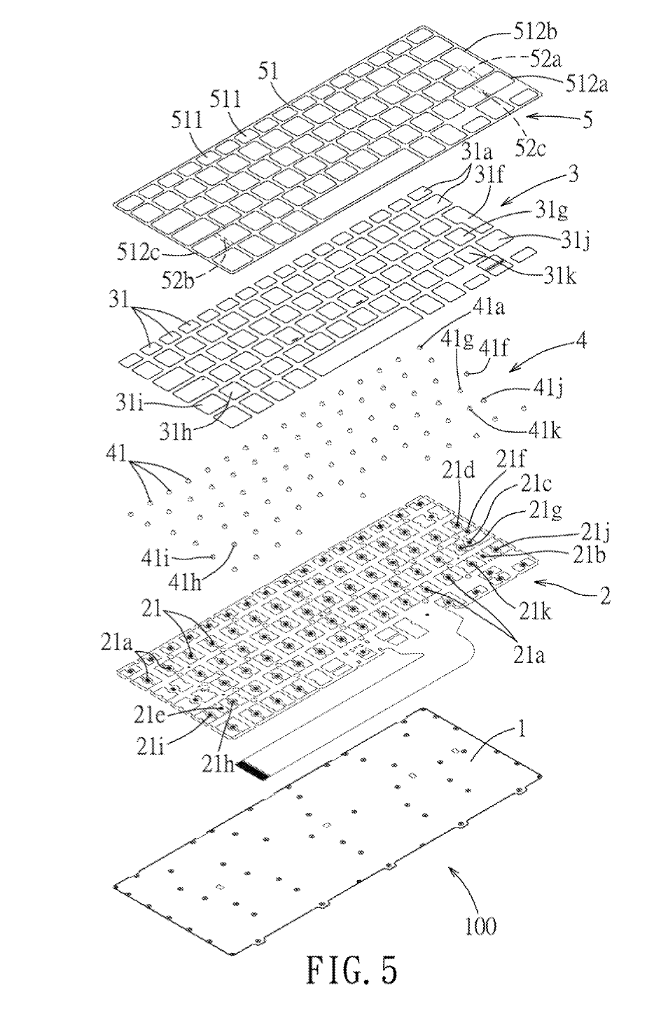

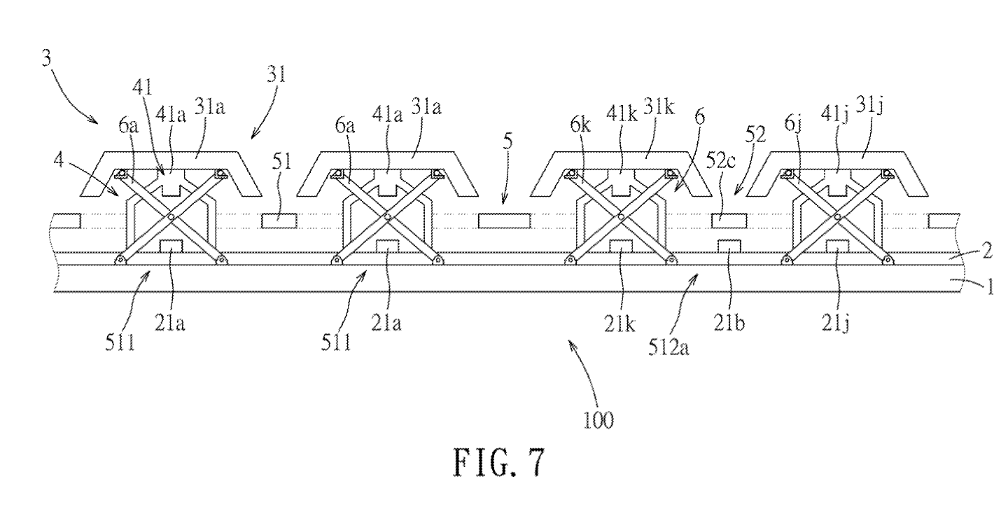

FIGS. 5 and 7 show a Portuguese Brazil keyboard of the first embodiment according to this disclosure.

The Portuguese Brazil keyboard (Example 3) has a structure similar to that of the British keyboard (Example 2) except for the keycap unit 3, the elastic members 41 and the partition strip 52.

The keycaps 31a, 31f, 31g, 31h, 31i are similar to those of Example 2. The keycap 31b of Example 2 is replaced by the keycaps 31j, 31k (comparing FIGS. 3 and 5).

The elastic members 41a, 41f, 41g, 41h, 41i are similar to that of Example 2. The elastic members 41j, 41k replace the elastic members 41b of Example 2 and are respectively disposed under the keycaps 31j, 31k.

In this example, the frame structure 5 includes three partition strips 52a, 52b, 52c. The partition strip 52a is mounted on the second frame 512b and is disposed between the keycaps 31f, 31g received in the second frame 512b so as to partition the keycaps 31f, 31g. The partition strip 52b is mounted on the second frame 512c and is disposed between the keycaps 31h, 31i received in the second frame 512c so as to partition the keycaps 31h, 31i. The partition strip 52c is mounted on the second frame 512a and is disposed between the keycaps 31j, 31k received in the second frame 512a so as to partition the keycaps 31j, 31k.

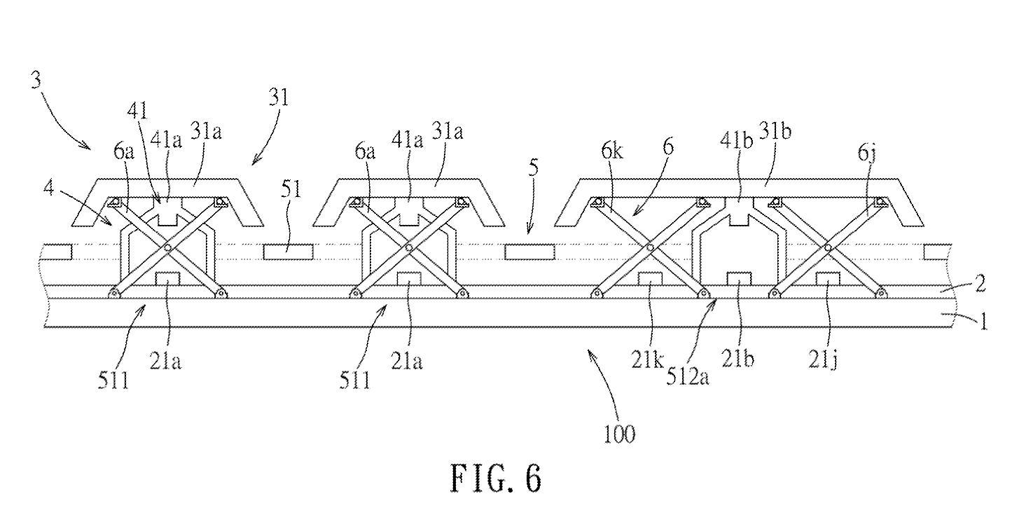

Comparing FIGS. 6 and 7, as shown in FIG. 6, for the British keyboard, the keycap 31b covers the triggers 21b, 21j, 21k. However, as shown in FIG. 7, for the Portuguese Brazil keyboard, the keycaps 31j, 31k replace the keycap 31b in the British keyboard and respectively cover the triggers 21j, 21k. That is to say, the keycap 31j is only connected to the elastic member 41j and only covers the trigger 21j. The keycap 31k is only connected to the elastic member 41k and only covers the trigger 21k. When the keycaps 31j, 31k are pressed, the elastic members 41j, 41k are pressed to deform so as to activate the triggers 21j, 21k which are not used in the British keyboard.

To sum up, though the layout of the keycaps 31 are different in different types of the keyboards, due to the configuration of the keyboard base 1, the circuit board 2, the main frame unit 51 and the guiding structure 6, the aforesaid elements are compatible elements that are suitable for all the American keyboard, the British keyboard and the Portuguese Brazil keyboard, thereby increasing the compatibility of the elements. The configuration of the keycaps 31, the elastic members 41 and the partition strip(s) 52 can be adjusted to meet actual requirements depending on the type of the keyboard.

### The Second Embodiment

### (1) Example 4

### American Keyboard

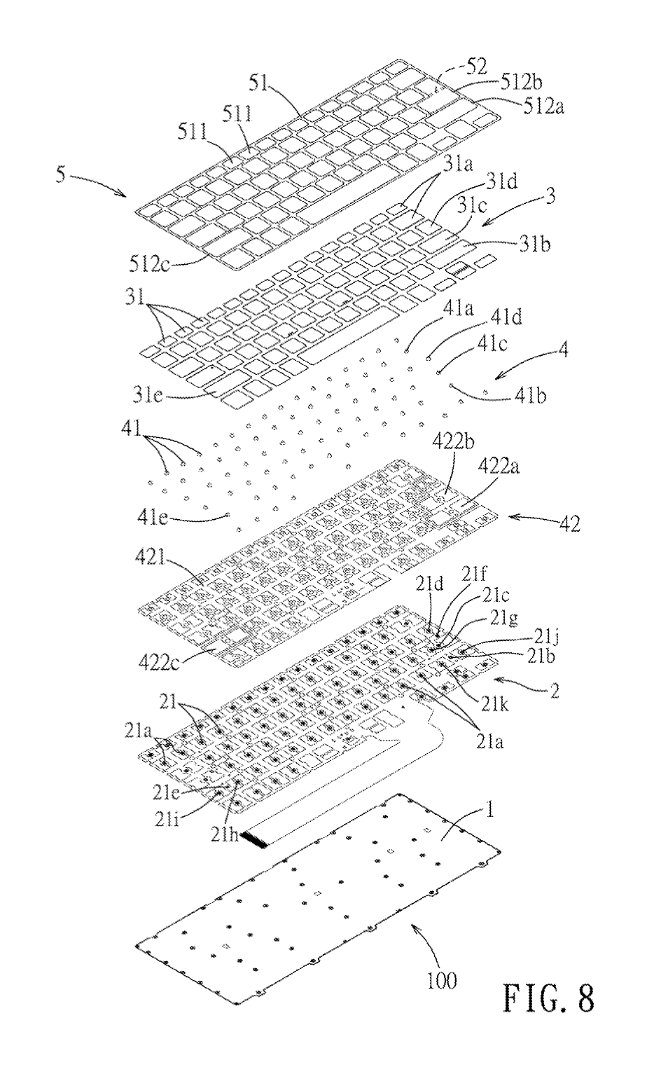

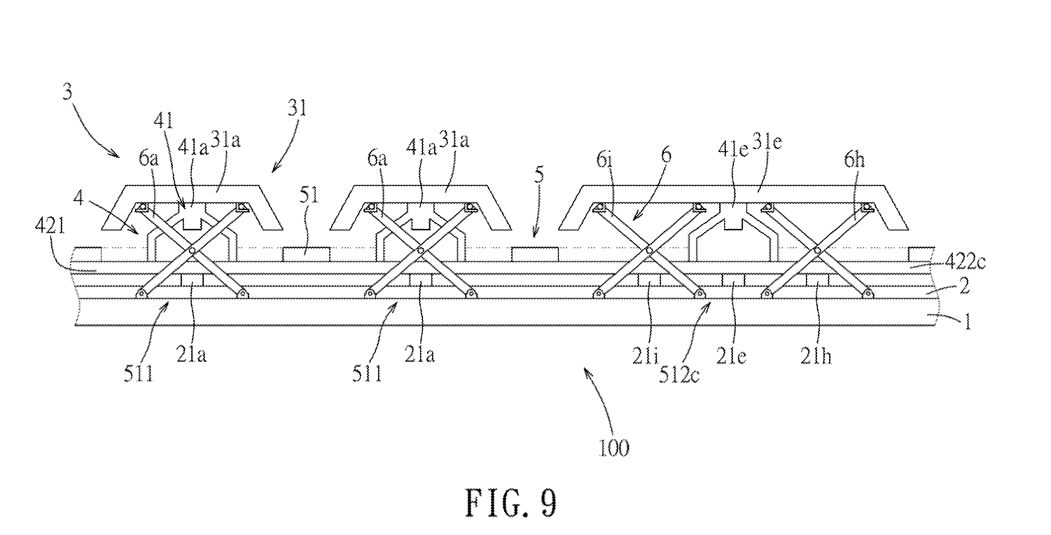

FIGS. 8 and 9 show a American keyboard of the second embodiment according to this disclosure.

To be specific, the American keyboard of Example 4 of the second embodiment has a structure similar to that of the American keyboard of Example 1 of the first embodiment except that the elastic unit 4 further includes a keyboard membrane 42 disposed between the circuit board 2 and the frame structure 5. The keyboard membrane 42 permits the elastic members 41 to be disposed thereon, and includes a first membrane portion 421 and at least one second membrane portion 422. The first membrane portion 421 of the keyboard membrane 42 is corresponding in position to the first frames 511. The second membrane portion 422 of the keyboard membrane 42 is corresponding in position to the second frame 512 and is spaced apart from the first membrane portion 421. The first membrane portion 421 is a compatible element, and the second membrane portion 422 is an incompatible element. In this example, the keyboard membrane 42 includes three second membrane portions 422a, 422b, 422c which are respectively corresponding in position to the second frames 512a, 512b, 512c. It should be noted that the configuration of the second membrane portions 422 can be changed to meet different types of the keyboard while the first membrane portion 421 can be used for all types of the keyboards.

It should be noted that, in this example, the elastic members 41 is adhered to the first and second membrane portions 421, 422. However, in a variation of this example, some of the elastic members 41 and the first membrane portions 421 are formed to serve as onepiece, and the other elastic members 41 and the second membrane portions 422 are formed to serve as onepiece. When one of the keycaps 31 is pressed, the corresponding elastic member 41 is deformed and pressed by the keycap 31 against the corresponding keyboard membrane 42 so as to activate the corresponding trigger 21.

### (2) Example 5

### British Keyboard

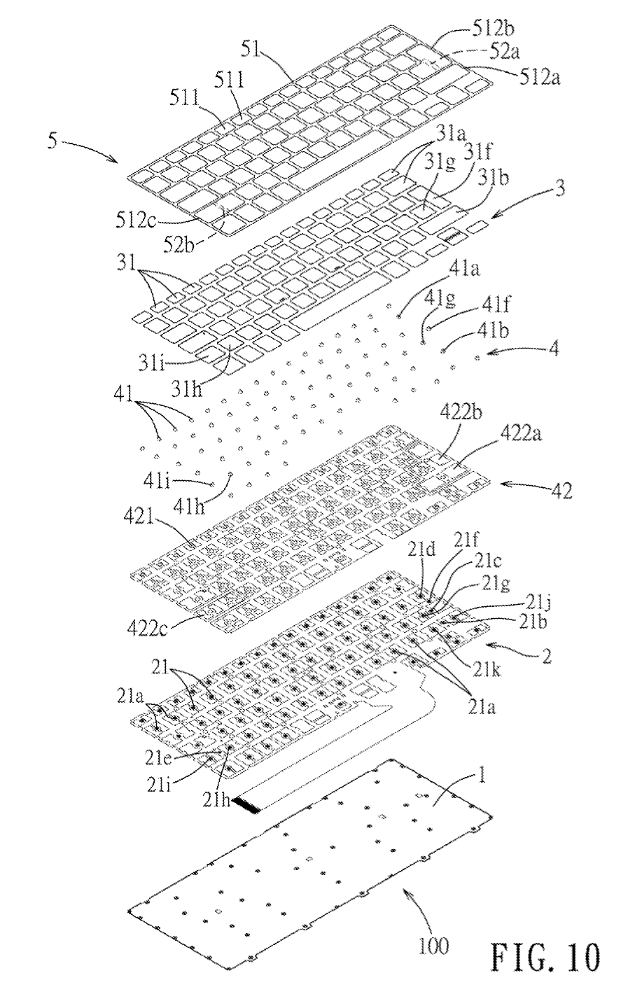

FIGS. 10, 11 and 13 show a British keyboard of the second embodiment according to this disclosure.

The British keyboard (Example 5) has a structure similar to that of the American keyboard (Example 4) of the second embodiment except for the keycap unit 3, the elastic members 41 and the partition strip 52.

The keycaps 31a, 31b are similar to those of Example 4. The keycaps 31c, 31d of Example 4 are replaced by the keycaps 31f, 31g. The keycap 31e of Example 4 is replaced by the keycaps 31h, 31i (comparing FIGS. 8 and 10).

The elastic members 41a, 41b are similar to those of Example 4. The elastic members 41f, 41g, 41h, 41i replace the elastic members 41c, 41d, 41e of Example 4 and are respectively disposed under the keycaps 31f, 31g, 31h, 31i to bias the elastic members 41 to their original positions. To be specific, in this example, the elastic member 41b is corresponding in position to the second membrane portion 422a. The elastic members 41f, 41g are corresponding in position to the second membrane portion 422b. The elastic members 41h, 41i are corresponding in position to the second membrane portion 422c.

In this example, the frame structure 5 includes two partition strips 52a, 52b. The partition strip 52a is mounted on the second frame 512b and is disposed between the keycaps 31f, 31g received in the second frame 512b so as to partition the keycaps 31f, 31g. Similarly, the partition strip 52b is mounted on the second frame 512c and is disposed between the keycaps 31h, 31i received in the second frame 512c so as to partition the keycaps 31h, 31i.

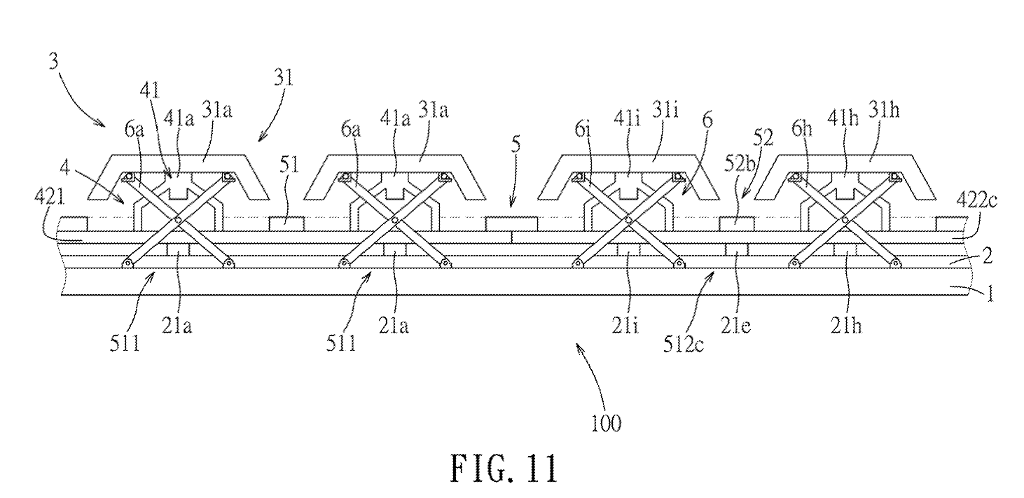

Comparing FIGS. 9 and 11, as shown in FIG. 9, for the American keyboard of the second embodiment, the keycap 31e covers the triggers 21e, 21h, 21i. However, as shown in FIG. 11, for the British keyboard of the second embodiment, the keycaps 31h, 31i replace the keycap 31e in the American keyboard and respectively cover the triggers 21h, 21i. That is to say, the keycap 31h is only connected to the elastic member 41h and only covers the trigger 21h. The keycap 31i is only connected to the elastic member 41i and only covers the trigger 21i. When the keycaps 31h, 31i are pressed, the elastic members 41h, 41i are pressed to deform so as to activate the triggers 21h, 21i which are not used in the American keyboard of the second embodiment (Example 4).

To sum up, though the layout of the keycaps 31 are different in different types of the keyboards, due to the configuration of the keyboard base 1, the circuit board 2, the main frame unit 51 and the guiding structure 6, the aforesaid elements are compatible elements that are suitable for both the American keyboard and the British keyboard, thereby increasing the compatibility of the elements. The configuration of the keycaps 31, the elastic members 41 and the partition strip(s) 52 can be adjusted to meet actual requirements depending on the type of the keyboard.

### (3) Example 6

### Portuguese Brazil Keyboard

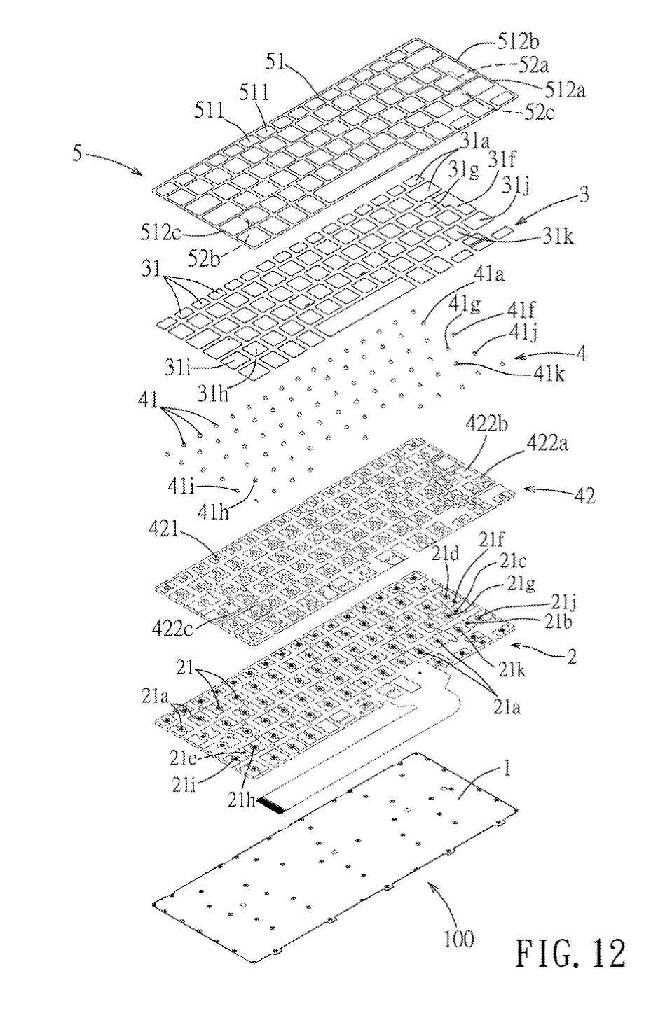

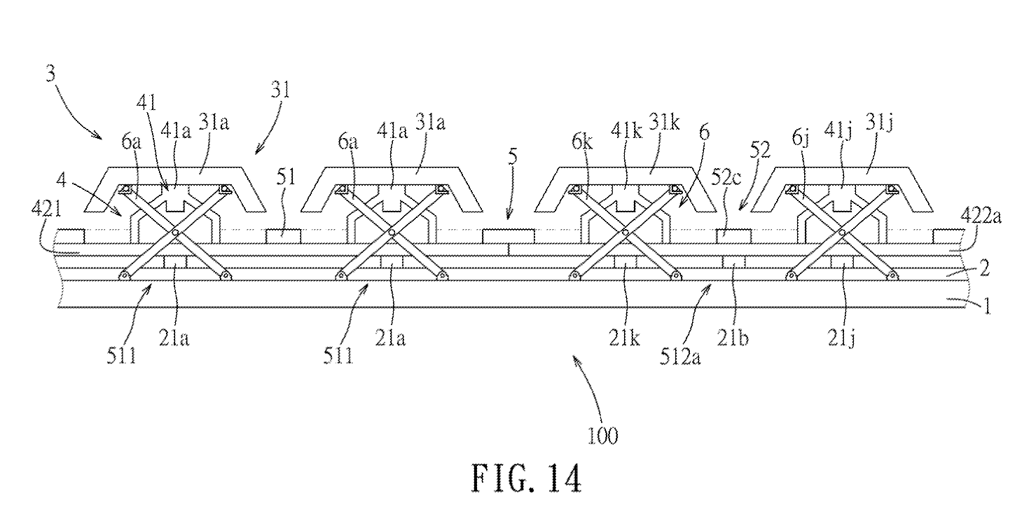

FIGS. 12 and 14 show a Portuguese Brazil keyboard of the second embodiment according to this disclosure.

The Portuguese Brazil keyboard (Example 6) has a structure similar to that of the British keyboard (Example 5) except for the keycap unit 3, the elastic members 41 and the partition strip 52.

The keycaps 31a, 31f, 31g, 31h, 31i are similar to those of Example 5. The keycap 31b of Example 2 is replaced by the keycaps 31j, 31k (comparing FIGS. 10 and 12).

The elastic members 41a, 41f, 41g, 41h, 41i are similar to those of Example 5. The elastic members 41j, 41k replace the elastic members 41b of Example 5 and are respectively disposed under the keycaps 31j, 31k.

In this example, the frame structure 5 includes three partition strips 52a, 52b, 52c. The partition strip 52a is mounted on the second frame 512b and is disposed between the keycaps 31f, 31g. The partition strip 52b is mounted on the second frame 512c and is disposed between the keycaps 31h, 31i. The partition strip 52c is mounted on the second frame 512a and is disposed between the keycaps 31j, 31k.

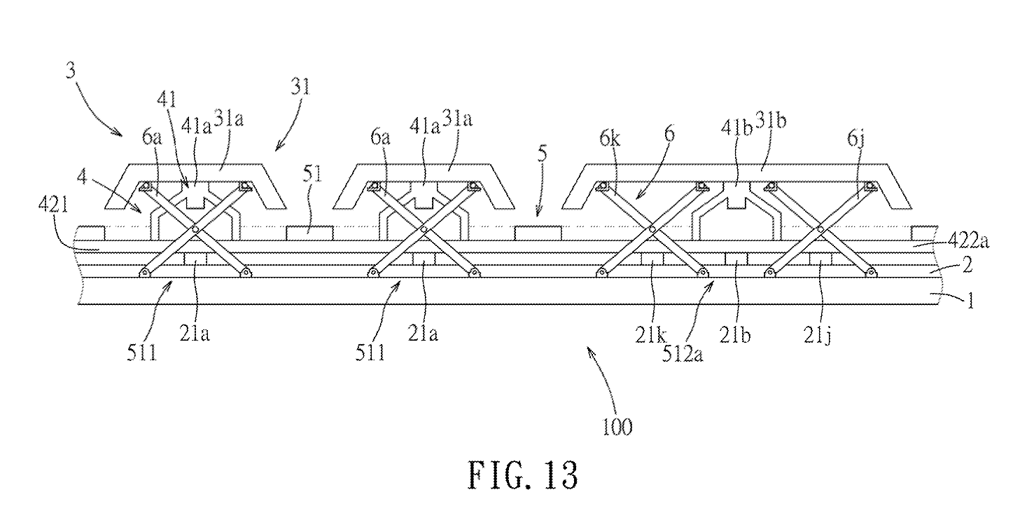

Comparing FIGS. 13 and 14, as shown in FIG. 13, for the British keyboard, the keycap 31b covers the triggers 21b, 21j, 21k. However, as shown in FIG. 14, for the Portuguese Brazil keyboard, the keycaps 31j, 31k replace the keycap 31b in the British keyboard and respectively cover the triggers 21j, 21k. That is to say, the keycap 31j is only connected to the elastic member 41j and only covers the trigger 21j. The keycap 31k is only connected to the elastic member 41k and only covers the trigger 21k. When the keycaps 31j, 31k are pressed, the elastic members 41j, 41k are pressed to deform so as to activate the triggers 21j, 21k which are not used in the British keyboard.

To sum up, though the layout of the keycaps 31 are different in different types of the keyboards, due to the configuration of the keyboard base 1, the circuit board 2, the main frame unit 51 and the guiding structure 6, the aforesaid elements are compatible elements that are suitable for all the American keyboard, the British keyboard and the Portuguese Brazil keyboard, thereby increasing the compatibility of the elements. The configuration of the keycaps 31, the elastic members 41 and the partition strip(s) 52 can be adjusted to meet actual requirements depending on the type of the keyboard. In the second embodiment, the elastic members 41a are adhered to the first membrane portion 421 so that the first membrane portion 421 and the elastic members 41a can be massively and conveniently manufactured.

In conclusion, the keyboard device 100 according to this disclosure is advantageous for the following reasons. The number of the triggers 21 is greater than that of the keycaps 31 so as to enable the circuit board 2 to be a compatible element that are suitable for all types of the keyboards. The configuration of the second frames 512 and the partition strips 52 can be adjusted to meet the different layouts of the keycaps 31 in each type of the keyboards. Therefore, in this disclosure, the keyboard base 1, the circuit board 2, the main frame unit 51, and the guiding structure 6 are compatible elements. Therefore, the compatibility of the elements is enhanced, thereby reducing the manufacturing cost and the storage cost of the keyboard device 100.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A keyboard device comprising:
a keyboard base;
a circuit board disposed on said keyboard base and including a plurality of triggers that are spaced apart from one another;
a keycap unit disposed on a side surface of said circuit board opposite to said keyboard base and including a plurality of keycaps that are spaced apart from one another, number of said keycaps being less than that of said triggers, each of said keycaps covering at least one of said triggers, each of at least two of said keycaps covering a plurality of said triggers; and
an elastic unit including a plurality of elastic members each being disposed between a corresponding one of said keycaps and a corresponding one of said triggers, number of said elastic members being less than that of said triggers, wherein, when one of said elastic members is pressed by a corresponding one of said keycaps, the one of said elastic members activates said corresponding one of said triggers.

2. The keyboard device as claimed in claim 1, further comprising a frame structure that includes
a main frame unit disposed on said circuit board opposite to said keyboard base and including a plurality of first frames and at least two second frames each defining a hole, each of said first frames defining a hole for receiving a corresponding one of said keycaps therein, at least one of said holes of said second frames receiving a plurality of corresponding ones of said keycaps therein, and
at least one partition strip mounted on one of said second frames and disposed between two of said keycaps received in the one of said second frames so as to partition said keycaps received in the one of said second frames.

3. The keyboard device as claimed in claim 1, further comprising a plurality of guiding structures each interconnecting a corresponding one of said keycaps and said keyboard base to guide the corresponding one of said keycaps to move upwardly and downwardly, each of said keycaps being connected to at least one of said guiding structures, number of said guiding structures being less than that of said triggers.

4. The keyboard device as claimed in claim 1, wherein said elastic members are adhered to said circuit board.

5. The keyboard device as claimed in claim 2, wherein said elastic unit further includes a keyboard membrane disposed between said circuit board and said frame structure, permitting said elastic members to be disposed thereon, and including a first membrane portion and at least one second membrane portion, said first membrane portion of said keyboard membrane being corresponding in position to said first frames, said second membrane portion of said keyboard membrane being corresponding in position to said second frame and spaced apart from said first membrane portion.
